(19) United States
(12) Patent Application Publication
(10) Pub. No.: US 2025/0091303 A1
(43) Pub. Date: Mar. 20, 2025

(54) METHOD FOR MANUFACTURING A COMPOSITE PART, IN PARTICULAR AN AERONAUTICAL COMPOSITE PART AND ASSOCIATED SYSTEM

(71) Applicant: SAFRAN AIRCRAFT ENGINES, Peris (FR)

(72) Inventors: Matteo MINERVINO, Moissy-Cramayel (FR); Nicolas DROZ, Moissy-Cramayel (FR); Thierry Claude Henri GODON, Moissy-Cramayel (FR); Maxime Marie Desire BLAISE, Moissy-Cramayel (FR)

(21) Appl. No.: 18/294,499

(22) PCT Filed: Aug. 21, 2022
(86) PCT No.: PCT/FR2022/051591

§ 371 Date: Feb. 1, 2024

(30) Foreign Application Priority Data
Aug. 27, 2021 (FR) FR2108964

(51) Int. Cl. B29C 70/54; B29C 70/48

(52) U.S. Cl. CPC B29C 70/54; B29C 70/48

(57) ABSTRACT

A method for manufacturing a composite part, in particular an aeronautical composite part, in which the method includes the steps of heating a mixture of a polymerisable resin and a curing agent to a temperature and/or for a period of time sufficient to ensure that the curing agent is completely dissolved; cooling the mixture to a safety temperature so as to prevent at least one exothermic reaction; subsequently or immediately injecting the mixture into a mould including a fibrous preform at an injection temperature equal to or higher than the dissolution temperature.

### TECHNICAL FIELD OF THE INVENTION

This invention relates to a method for manufacturing a composite part, in particular an aeronautical composite part, as well as a system for implementing such a method.

### TECHNICAL BACKGROUND

The prior art comprises in particular the documents FR-A1-3 051 386, FR-A1-3 100 739, EP-A1-1 908 565, EP-A1-2 256 163, EP-A1-3 819 331, U.S. Pat. No. 5,591,252 and FR-A1-3 101 570.

The use of composite materials is advantageous in the aeronautical industry in particular because these materials have interesting mechanical performances for relatively low masses.

A method for manufacturing a composite part for the aeronautical industry, which is well known to the person skilled in the art, is the moulding method RTM, the initials of which refer to the acronym Resin Transfer Molding.

This is a method for producing a composite material part based on fibres impregnated with a resin-based mixture. Such a method is used, for example, to manufacture an aeronautical composite part, such as a turbomachine bladed part, for example a fan vane or a stator vane blading. The fibres used may be carbon and/or glass and/or Kevlar fibres, and/or any other material.

A RTM method comprises several successive steps.

Fibres are first woven together to produce a three-dimensional preform blank, and the blank is then cut to produce a preform substantially in the shape of the bladed part to be produced. This preform is then placed in a mould, which is closed. A liquid resin-based mixture is then injected, maintaining pressure on the injected mixture while the part is polymerised by heating.

The resulting part is removed from the mould and any machining and/or bonding operations can be carried out.

The current injection line consists of:
an injection cylinder where the resin-based mixture is heated to a temperature of between 80° C. and 120° C., after a vacuum degassing phase;
a heater in which a solid state curing agent in the resin mixture is dissolved and the mixture reaches the optimum injection temperature (between 155° C. and 170° C. for a PR520N type resin), i.e. the temperature at which the viscosity is minimal (<100 cP);
a press mould, when the resin-based mixture has filled the cavity and the fibrous preform placed in the mould is completely impregnated, the assembly is heated to the curing temperature (between 170° C. and 200° C. for a PR520N type resin);
a vacuum system to prevent air from remaining inside the cavity of the mould and forming porosities and/or dry areas. The vacuum also helps to infuse the resin into the fibres making up the reinforcement.

Before the injection step, the resin-based mixture is preheated to make it liquid. Heating the mixture before it is injected into the mould is very important. It is important that one of the components of the mixture, a curing agent, has completely dissolved in the mixture before it comes into contact with the preform, as there is a risk of this component being filtered into the preform, and the mechanical properties of the resin during curing would not be maintained.

In the current technique, preheating of the resin-based mixture to dissolve the curing agent is carried out in a heater in which the resin is heated to at least 150° C. (or even at least 160° C.).

There are different types of heater.

For example, a thin film heater. The resin circulates between two hot walls in a thin layer (about 0.1 mm). The heat exchange is optimised by the thin layer of resin exposed to the heat flow. However, the flow rate of resin that can be heated is limited, which leads to a limitation in the maximum size of the part to be injected.

It can also be a heater consisting of a series of superimposed hot plates in which at least one serpentine channel is hollowed out. The number of plates and the dimensions of the channel or channels determine the volume treated. The duration of the resin within it is directly linked to the flow rate and to its volume. Controlling the temperature and the time the resin is allowed to pass through the heater is therefore complex, leading to a risk of poor dissolution of the curing agent or premature crosslinking of the resin, resulting in clogged conduits.

It can also be a thermal exchanger with a heat transfer fluid. This solution requires a secondary system for pumping and heating the heat transfer fluid. This system is more time-consuming, more expensive and more difficult to implement than the previous solutions because it requires a high-performance hot seal.

The heaters we know are dynamic heat exchange systems, with many parameters to keep under control: the temperature of the plates, the resin inlet temperature, the time the resin is inside the system, the resin flow rates, the state of advancement of the resin at the inlet to the system (which can have a major influence on its viscosity), etc. Dissolving the curing agent is therefore difficult to control.

In addition, a certain volume of resin remains lost in these heater systems, resulting in significant resin losses and a significant additional cost.

The present invention offers a simple, effective and economical solution to these problems.

### SUMMARY OF THE INVENTION

The invention relates to a method for manufacturing a composite part, in particular an aeronautical composite part, wherein the method comprises the steps of:
a) heating a mixture of a polymerisable resin and a curing agent to a dissolving temperature and/or for a dissolving time sufficient to obtain a complete dissolution of the curing agent,
b) cooling the mixture to a safety temperature so as to prevent at least one exothermic reaction,
c) subsequently or immediately injecting the mixture into a mould comprising a fibrous preform at an injection temperature equal to or higher than the dissolution temperature.

It was observed that the curing agent could be dissolved in the resin by a heating step and maintained even when the mixture cooled.

It is therefore no longer necessary to preheat the mixture before the injection in a preheater, which limits the flow rate of the mixture and therefore the size of the composite part to be manufactured.

Furthermore, as the curing agent does not recrystallise in the resin when the temperature of the mixture decreases, it is possible not to inject the mixture immediately but in a later step.

It is therefore possible to simplify the system used and limit the amount of resin lost at the end of a method for manufacturing a part.

It is also possible to increase the injection flow rate, allowing the manufacture of large parts.

The method makes it easy to dissolve the curing agent in the resin by means of a heating step and a cooling step before this mixture is injected into the mould comprising the fibrous preform.

The method according to the invention may comprise one or more of the following characteristics, taken alone or in combination with each other:
the dissolution time is chosen so that the percentage of resin crosslinking is less than 5%;
the dissolution temperature is chosen so that the percentage of resin crosslinking is less than 5%;
the dissolution temperature is between 80 and 170° C., preferably between 120 and 165° C.;
the injection temperature is between 120 and 160° C.;
heating step a) is carried out by mixing the mixture;
cooling step b) is carried out by mixing the mixture;
the safety temperature is below 80° C.;
the transition from the dissolution temperature to the safety temperature takes place in less than 1 min; a person skilled in the art is able to adapt the temperature reduction rate to ensure that this time of less than 1 min between the value of the dissolution temperature and the value of the safety temperature is respected;
the transition from the dissolution temperature to the safety temperature takes less than 10 seconds; a person skilled in the art is able to adapt the temperature reduction rate to ensure that this time of less than 10 seconds between the value of the dissolution temperature and the value of the safety temperature is maintained;
the transition from the dissolution temperature to the safety temperature takes place in less than 1 min for a dissolution temperature of less than 140° C.; the person skilled in the art is able to adapt the temperature reduction rate to achieve this time of less than 1 min between the value above 140° C. and the value of the safety temperature;
the transition from the dissolution temperature to the safety temperature takes less than 10 sec for a dissolution temperature of more than 140° C.; the person skilled in the art will be able to adapt the temperature reduction rate to achieve this time of less than 10 sec between the value of more than 140° C. and the value of the safety temperature;
steps a), b) and/or c) of the method are carried out under vacuum;
the method comprises a step of storing the mixture between step b) and step c) at a storage temperature above 0° C., preferably a temperature between 0° C. and 5° C.;
the composite part is an aeronautical composite part, for example a turbomachine bladed part, such as a fan vane.

The present invention also relates to a system for implementing a method as described above.

According to the invention, the system comprises an area for mixing the resin and the curing agent, a device for dissolving the curing agent in order to carry out steps a) and b) of said method and a mould for receiving a fibrous preform and injecting resin for impregnating said preform in order to carry out step c) of said method.

The system according to the invention may comprise one or more of the following characteristics, taken in isolation from each other or in combination with each other:
the system comprises a heating area for carrying out step a) of said method;
the system comprises a cooling area for carrying out step b) of said method;
the system comprises a pumping means for conveying the mixture from the mixing area towards the device for dissolving the curing agent;
the system also comprises a storage area for carrying out the storage step;
the storage area is separate from the mixing area, the heating area, the cooling area and/or the mould.

The system may comprise any element allowing the steps of the above method to be carried out.

### BRIEF DESCRIPTION OF THE FIGURES

Further characteristics and advantages will be apparent from the following description of a non-limiting embodiment of the invention with reference to the appended drawings in which:

FIG. 1 is a very schematic view of a first example of a system according to the invention for manufacturing a composite part;

FIG. 2 is a very schematic view of a second example of a system according to the invention for manufacturing a composite part;

FIG. 3 is a very schematic view of a third example of a system according to the invention for manufacturing a composite part;

FIG. 4 is a very schematic view of a dissolution device from the system shown in FIGS. 2 and 3 and a graph showing the change in temperature during steps a) and b) of the method according to the invention as a function of the length of the device;

FIG. 5 is a very schematic view of an example of a method according to the invention for manufacturing a composite part.

### DETAILED DESCRIPTION OF THE INVENTION

Generally speaking, a method for manufacturing a composite part, in particular an aeronautical composite part, comprises several successive steps:
weaving the fibres to obtain a three-dimensional preform blank,
cutting the blank to obtain a fibrous preform 10 having substantially the shape of the aeronautical part to be obtained,
placing the fibrous preform 10 in a mould 12,
injecting a resin-based mixture in a liquid state, maintaining a pressure while the part is polymerised by heating.

The composite part is an aeronautical composite part, for example a turbomachine bladed part, such as a fan vane.

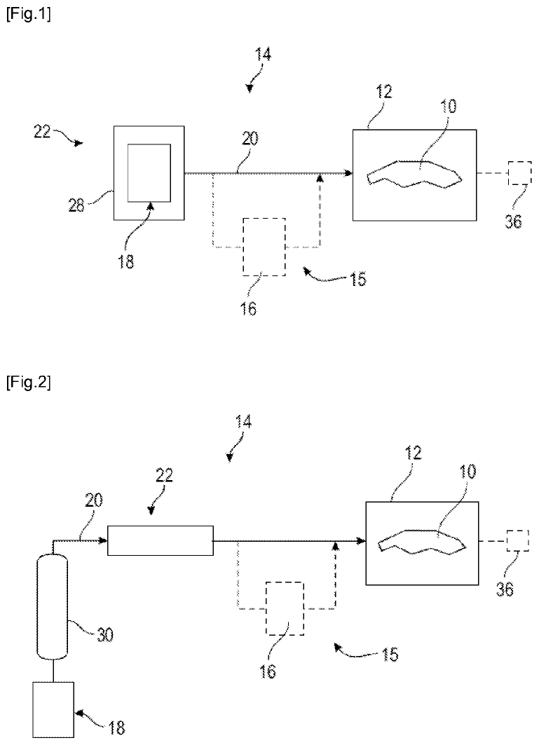

Examples of systems 14 allowing for implementing such a method are shown in FIGS. 1 to 3.

Typically, the resin-based mixture comprises at least one polymerisable resin and a curing agent.

Advantageously, the resin is a thermosetting material. Preferably, the resin is in liquid form. Examples include polyepoxides (or epoxides), polyimides or polybismaleimides.

Preferably, the resin is a polyepoxide resin, for example the resin PR520N marketed by Solvay, based on DiGlycidyl Ether of Bisphenol F (DGEBF) or the resin 2896, marketed by 3M, based on DiGlycidyl Ether of Bisphenol A (DGEBA).

The curing agent is a crosslinking agent that triggers the polymerisation and the irreversible hardening of the resin under the effect of heat.

Preferably, the curing agent is in solid form.

Advantageously, the curing agent is chosen from, for example, 9,9-Bis(4-amino-3chlorophenyl)fluorene (CAF), 1,12-dodecanedioic acid (DDA), 4,4′-diamino-diphenylsulfone (DDS) and hexamethylene diamine (HDMA).

The mixture may also comprise other components such as a filler. Preferably, the filler represents less than 30% by weight of the mixture, 10% maximum for the elastomer fillers. The aim is to improve certain physical, chemical and/or mechanical characteristics of the product.

For optimum results, particularly in terms of the mechanical properties of the resin after curing, the curing agent must be dissolved in the resin before injection into the mould 12.

According to the invention, the method for manufacturing a composite part, in particular an aeronautical composite part, further comprises the steps consisting of:
a) heating the mixture of polymerisable resin and curing agent to a dissolving temperature and/or for a dissolving time sufficient to dissolve the curing agent completely, and
b) cooling the mixture to a safety temperature so as to prevent at least one exothermic reaction.

Subsequently, in a step c), the mixture is injected, subsequently or immediately after the mixture has cooled, into the mould 12 comprising the fibrous preform 10. The mixture is injected at an injection temperature equal to or higher than the dissolution temperature.

The method according to the invention applies, for example, to the manufacture of a bladed part, such as a vane and in particular a fan vane.

During heating step a), the mixture is heated so that the curing agent dissolves, i.e. passes from the solid state to the liquid state and mixes with the liquid resin.

Advantageously, the dissolution time during heating step a) is chosen so that the percentage of resin crosslinking is less than 5%.

The dissolution time is between 2 and 60 min, preferably between 2 and 30 min, more preferably between 2 and 15 min.

Similarly, the dissolution temperature is chosen so that the percentage of crosslinking of the resin is less than 5%.

Preferably, the dissolution temperature is between 80 and 170° C., preferably between 120 and 165° C. This temperature is chosen and adapted according to the type of resin and type of curing agent. For example, for the resin PR520N, a mixture of a DBEGF type polymer and curing agent CAF, the dissolution temperature is between 155° C. and 170° C., preferably the dissolution temperature is around 160° C.

A crosslinking percentage of the resin of less than 5% ensures that the mixture has the right viscosity to be injected into the mould 12.

Furthermore, to improve and facilitate the dissolution of the curing agent and thus obtain satisfactory and total dissolution of the curing agent, step a) heating and/or step b) cooling can be carried out with mixing of the mixture.

Advantageously, steps a), b) and/or c) of the method can be carried out under vacuum. In particular, this avoids incorporating air into the mixture, which could then impair its behaviour during injection, and prevents air from remaining inside the cavity of the mould 12 and forming porosities and/or dry areas. The vacuum also helps to infuse the resin into the fibres making up the preform 10.

During the injection step, the injection temperature is typically between 120 and 160° C.

Advantageously, the method can also comprise a step of storing the mixture between step b) and step c) at a storage temperature above 0° C., preferably between 0° C. and 5° C.

It was observed that after cooling, the dissolved resin and curing agent mixture could be kept at temperatures below the dissolution temperature or the injection temperature. This is because, contrary to all expectations, the curing agent does not recrystallise after the temperature is lowered, particularly during cooling step b). The dissolved curing agent remains in the liquid state if the resin is kept at a temperature above 0° C., preferably between 0° C. and 5° C.

It is therefore not necessary to inject the mixture immediately into the mould 12. This can be stored, for example in a storage area 15, at a storage temperature above 0° C., preferably between 0° C. and 5° C., as shown in FIGS. 1 to 3.

Advantageously, the storage area 15 is separate from and independent of the mixing area 18, the heating area 24, the cooling area 26 and/or the mould 12. In this way, the storage area 15 can be an unlinked area, not attached to the other areas of the system 14 and not dependent on them. In other words, the storage area 15 can be an area external to the other areas and operate independently of them.

The storage area 15 can be a canister 16, for example.

The mixture of resin and dissolved curing agent can then be injected into a mould 12 without the need for integrating in the method a preheating step to dissolve the curing agent. This not only saves time, but also simplifies the system 14 and manufacture.

Examples of system 14 for manufacturing a composite part allowing the implementation of the method according to the invention to be implemented are shown in FIGS. 1 to 3.

In each of the examples, the system 14 essentially comprises:
a mixing area 18 for a polymerisable resin and for the curing agent,
a mould 12 for receiving a fibrous preform 10 and injecting resin to impregnate said preform 10,
a system 20 of conduits for conveying the resin from one element of the system 14 towards another.

The system 14 may also comprise other elements, whether or not they are shown in the drawings.

The various elements of the system 14 can be connected to remote monitoring and control means, such as computerised systems, for example.

According to the invention, the system 14 comprises a device 22 for dissolving the curing agent.

The device 22 for dissolving the curing agent comprises a heating area 24 and a cooling area 26.

The heating area 24 allows to carry out step a) of the method according to the invention and described above, i.e. a step in which the mixture of polymerisable resin and curing agent is heated to a dissolution temperature and/or for a dissolution time sufficient to obtain complete dissolution of the curing agent.

The cooling area 26 allows step b) of the method described above to be carried out, i.e. a step in which the mixture is cooled to a safety temperature so as to prevent at least one exothermic reaction.

FIG. 1 shows a first example of embodiment of a system 14 for implementing the method according to the invention.

In this first example, the heating 24 and cooling 26 areas are an oven 28 which forms the device 22 for dissolving the curing agent.

The mixture of resin and curing agent contained in the mixing area 18 is placed in an oven 28. The mixing area 18 can be, as here, a canister, such as the canister in which the resin is supplied.

Once placed in the oven 28, the mixture undergoes a thermal cycle which causes the curing agent to dissolve. The temperature of the oven 28, the heating ramps and the duration of the stages are selected so as to obtain a complete dissolution of the curing agent, and preferably a percentage of crosslinking of the resin of less than 5% as described above.

The mixture is then cooled by lowering the temperature of the oven 28, for example, to a safety temperature so as to prevent at least one exothermic reaction as described above.

The mixture can then either be stored in the storage area 15, such as a canister or the canister 16 in which the resin is supplied, for a subsequent injection into the mould 12, or be injected directly into the mould 12 comprising the fibrous preform 10.

To improve the dissolution of the curing agent and/or avoid exothermic reactions, it is advantageous to have, for example in the canister 16, a system allowing to move the mixture in order to homogenise the temperature between the core of the mixture and its surfaces.

A second example of embodiment of a system 14 allowing to implement the method according to the invention is shown in FIG. 2.

In this second example, the mixture of resin and curing agent contained in the mixing area 18, in this case a canister, such as the canister in which the resin is supplied, is loaded into a piston 30 used to convey it to the device 22 for dissolving the curing agent.

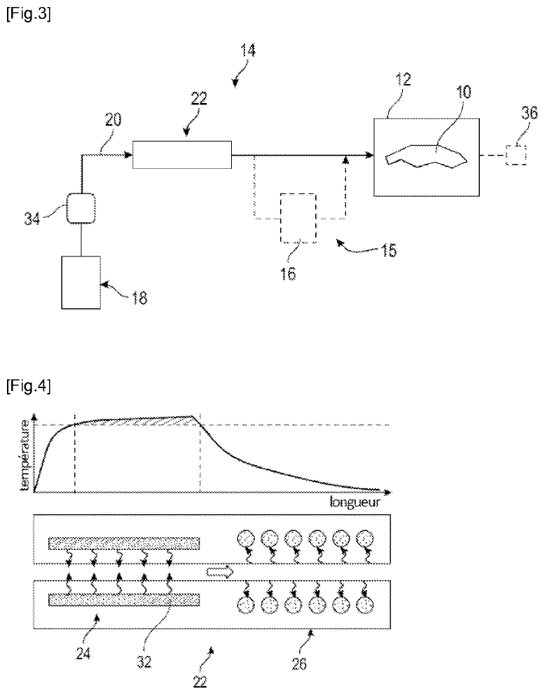

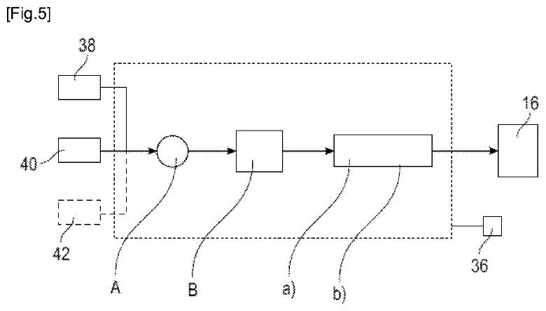

In this example of a dissolving device 22 shown in FIG. 4, the dissolving device 22 comprises the heating area 24 combined with the cooling area 26.

In this example, the heating area 24 is a “thin film” type heater implemented in the system 14. The “thin film” type heater is a system comprising two spaced hot walls 32, for example about 0.3 mm apart, between which the mixture circulates in the form of a thin film. The walls 32 can be heated by electric heating elements. The system allows to heat the mixture very quickly.

The heating area 24 is then coupled to a cooling system forming the cooling area 26.

For example, as shown in the graph in FIG. 4, the resin PR520N can be heated from 120° C. to 165° C. in less than five seconds, held at the dissolving temperature long enough for all the curing agent to dissolve, then the mixture is rapidly cooled to reach the safety temperature.

A third example of embodiment of a system 14 allowing to implement the method according to the invention is shown in FIG. 3.

This third example of system 14 differs from the second example in that it comprises a pumping means 34 allowing to supply the device 22 for dissolving the mixed curing agent.

The mixture of resin and curing agent contained in the mixing area 18, in this case a canister, such as the canister in which the resin is supplied, is collected by the pumping means 34 to bring it to the device 22 for dissolving the curing agent.

The pumping means 34 comprises a piston which pressurises the mixture of resin and curing agent inside the canister 16. The mixture then rises to the device 22 for dissolving the curing agent.

The device 22 for dissolving the curing agent may be similar to that in the second example.

Advantageously, steps a), b) and/or c) of the method can be carried out under vacuum. In this case, the system can comprise a vacuum system 36 allowing to create a vacuum in the system, particularly at the level of elements requiring a vacuum.

As shown in FIG. 5, the dissolving step a) and the cooling step b) can also be carried out during the preparation of the mixture, at the supplier's premises for example.

In a mixing step A), the liquid resin 38 is mixed with the solid curing agent 40 and possibly other components such as a solid filler 42, in a known manner and in such a way as to obtain a homogeneous mixture. This mixing step A) can be carried out in a mixer, for example.

Any aggregates can be eliminated in an aggregate elimination step B) by performing a specific treatment to break up and disperse the agglomerates of solid particles. This may involve extrusion, lamination or any other technique known in the art.

The mixture is then heated so as to carry out step a) of the method according to the invention and obtain complete dissolution of the curing agent, then cooled so as to carry out step b) of the method according to the invention to prevent at least one exothermic reaction.

Advantageously, the mixture is discharged from the mixer by means of a pressure applied inside the mixer to be placed in the aforementioned pot or pots or canister or canisters 16. This allows the manufacturing line to be completely emptied of the mixture and greatly reduces resin wastage.

The pots or canisters 16 can then be stored in the storage area 15 as described above.

Advantageously, in this example, steps A), B), a) and/or b) of the method can be carried out under vacuum. In this case, a vacuum system 36 is used to create a vacuum in the system, particularly at the level of the elements requiring vacuum.

The mixture thus obtained can then be directly injected into the mould 12 according to step c) of the method according to the invention without a preliminary preheating step to dissolve the curing agent.

1. A method for manufacturing a composite part, in particular an aeronautical composite part, wherein the method comprises the steps of:
a) heating a mixture of a polymerisable resin and a curing agent to a dissolving temperature and/or for a dissolving time sufficient to obtain a complete dissolution of the curing agent,
b) cooling the mixture to a safety temperature so as to prevent at least one exothermic reaction,
c) subsequently or immediately injecting the mixture into a mould comprising a fibrous preform at an injection temperature equal to or higher than the dissolution temperature.

2. The method according to claim 1, wherein the dissolution time and/or the dissolution temperature are chosen so that the percentage of crosslinking of the resin is less than 5%.

3. The method according to claim 1, wherein the dissolution temperature is between 80 and 170° C., preferably between 120 and 165° C.

4. The method according to claim 1, wherein the injection temperature is between 120 and 160° C.

5. The method according to claim 1, wherein the heating step a) and/or the cooling step b) are carried out with mixing of the mixture.

6. The method according to claim 1, wherein the safety temperature is less than 80° C.

7. The method according to claim 1, wherein the mixture is cooled with adaptation of the temperature reduction rate so that the transition from the dissolution temperature to the safety temperature is carried out in less than 1 min or even in less than 10 s.

8. The method according to claim 7, wherein the dissolution temperature is greater than 140° C.

9. The method according to claim 1, wherein steps a), b) and/or c) of the method are carried out under vacuum.

10. The method according to claim 1, wherein the method comprises a step of storing the mixture between step b) and step c) at a storage temperature above 0° C., preferably between 0° C. and 5° C.

11. A system for implementing the method according to claim 1, comprising an area for mixing the resin and the curing agent, a device for dissolving the curing agent in order to carry out steps a) and b) of said method and a mould for receiving a fibrous preform and for injecting resin for impregnating said preform in order to carry out step c) of said method.

12. The system according to claim 11, wherein the device for dissolving the curing agent comprises a heating area for carrying out step a) of said method and a cooling area for carrying out step b) of said method.

13. The system according to claim 11, comprising a pumping means for conveying the mixture from the mixing area towards the device for dissolving the curing agent.

14. The system according to claim 11, wherein the method comprises a step of storing the mixture between step b) and step c) at a storage temperature above 0° C., preferably between 0° C. and 5° C., the system further comprising a storage area for carrying out the storage step, the storage area being separate from the mixing area, the heating area, the cooling area and/or the mould.
